(19) United States
(12) Patent Application Publication
(10) Pub. No.: US 2023/0333278 A1
(43) Pub. Date: Oct. 19, 2023

(54) Identifying Naturally Fractured Sweet Spots Using a Fracture Density Index (FDI)

(71) Applicant: Saudi Arabian Oil Company, Dhahran (SA)

(72) Inventors: Otto Meza Camargo, Dhahran (SA); Karla Patricia Olvera Carranza, Dhahran (SA)

(21) Appl. No.: 17/721,064

(22) Filed: Apr. 14, 2022

(51) Int. Cl. G01V 99/00; E21B 49/08

(52) U.S. Cl. CPC G01V 99/005; E21B 49/087; E21B 2200/20

(57) ABSTRACT

A process for identifying natural fracture sweet spots in a hydrocarbon reservoir by integrating reservoir modeling components and reservoir dynamic data. A fracture density index (FDI) is determined using natural fracture predictions from geomechanics and identified fluid flow paths. Natural fracture sweet spots may be identified from the FDI and additional inputs such as a reservoir matrix model and dynamic reservoir properties. Systems and computer-readable media for identifying natural fracture sweet spots are also provided.

### BACKGROUND

### Field of the Disclosure

The present disclosure generally relates to the production of hydrocarbons from subsurface reservoirs. More specifically, embodiments of the disclosure relate to the determination of sweet spot intervals in certain naturally fractured reservoirs.

### Description of the Related Art

The extraction of hydrocarbon resources from reservoirs in rock formations may depend on a variety of factors. Some reservoirs may present particular challenges with respect to hydraulic fracturing and identifying suitable intervals for fracturing. Naturally fractured reservoirs may present such challenges. A variety of factors may pose different difficulties in exploitation of naturally fractured reservoirs. For example, natural fractures may be fluid-flow pathways and may affect reservoir dynamic performance and overall field development.

### SUMMARY

Natural fractures represent a key element in the characterization of hydrocarbon reservoirs. Stochastic discrete fracture model techniques may be used in the oil and gas industry to represent natural fractures within the reservoir. In some instances, natural fracture sweet spots may be identified via the construction of solid 3D fracture models and the integration of reservoir dynamic data. The reservoir dynamic data may provide information about reservoir fluid movement, such as heterogeneous fluid pathways, that may suggest a relationship with locally dense fracture networks.

Embodiments of the disclosure are directed to identifying natural fracture sweet spots by integrating hydrocarbon reservoir modeling components and reservoir dynamic data. As discussed in the disclosure, embodiments may include the identification of fluid-flow pathway distribution through a fracture density index model (FDI) using reservoir productivity indicators such as flow-capacity (PTA) and productivity index.

In one embodiment, a method for determining a sweet spot in a naturally fractured hydrocarbon reservoir is provided. The method includes obtaining reservoir parameters representing properties of the subsurface reservoir for processing in a data processing system, forming a natural fracture model by processing the obtained reservoir parameters in the data processing system to identify the presence and extent of natural fractures at locations in the subsurface hydrocarbon reservoir, and identifying a fluid flow path using a shear stress, a normal stress, and an aperture of a fracture. The method further includes determining a second discrete natural fracture network identifying the presence and extent of natural fractures representing fluid flow paths in the reservoirs and determining, using the second discrete natural fracture network, a fracture density index (FDI). Determining, using the second discrete natural fracture network, a fracture density index (FDI) includes generating a raster map from the second discrete natural fracture network, the raster map representing a fracture density per area. The method also includes obtaining a flow capacity parameter for the reservoir, the flow capacity parameter obtained from a pressure test analysis (PTA), obtaining a productivity index for the reservoir, and determining a sweet spot based on the fracture density index and at least one of the flow capacity parameter and the productivity index.

In some embodiments, identifying a fluid flow path using a shear stress, a normal stress, and an aperture associated of a fracture includes determining the aperture of the fracture in the naturally fractured hydrocarbon reservoir using a resistivity, a drilling fluid resistivity, and an excess current measurement, determining a shear stress associated with the fracture, the shear stress determined from reservoir parameters representing properties of the reservoir, determining a normal stress associated with the fracture, the normal stress determined from reservoir parameters representing properties of the reservoir, and identifying a fluid flow path using the shear stress, the normal stress, and the aperture. In some embodiments, the reservoir parameters include seismic attributes from seismic surveys of the subsurface geological structure. In some embodiments, the reservoir parameters include rock and mechanical properties from geological models of the subsurface geological structure. In some embodiments, the reservoir parameters include rock geological characterizations of the subsurface geological structure. In some embodiments, the reservoir parameters include reservoir engineering measures obtained from production from the subsurface hydrocarbon reservoir. In some embodiments, the method includes drilling a well in a subsurface geological structure to a location in the hydrocarbon reservoir based on the identified sweet spot.

In another embodiment, a non-transitory computer-readable storage medium having executable code stored thereon for determining a sweet spot in a naturally fractured hydrocarbon reservoir is provided. The executable code includes a set of instructions that causes a processor to perform operations that include obtaining reservoir parameters representing properties of the subsurface reservoir for processing in a data processing system, forming a natural fracture model by processing the obtained reservoir parameters in the data processing system to identify the presence and extent of natural fractures at locations in the subsurface hydrocarbon reservoir, and identifying a fluid flow path using a shear stress, a normal stress, and an aperture of a fracture. The operations further include determining a second discrete natural fracture network identifying the presence and extent of natural fractures representing fluid flow paths in the reservoirs and determining, using the second discrete natural fracture network, a fracture density index (FDI). Determining, using the second discrete natural fracture network, a fracture density index (FDI) includes generating a raster map from the second discrete natural fracture network, the raster map representing a fracture density per area. The operations also include obtaining a flow capacity parameter for the reservoir, the flow capacity parameter obtained from a pressure test analysis (PTA), obtaining a productivity index for the reservoir, and determining a sweet spot based on the fracture density index and at least one of the flow capacity parameter and the productivity index.

In some embodiments, identifying a fluid flow path using a shear stress, a normal stress, and an aperture associated of a fracture includes determining the aperture of the fracture in the naturally fractured hydrocarbon reservoir using a resistivity, a drilling fluid resistivity, and an excess current measurement, determining a shear stress associated with the fracture, the shear stress determined from reservoir parameters representing properties of the reservoir, determining a normal stress associated with the fracture, the normal stress determined from reservoir parameters representing properties of the reservoir, and identifying a fluid flow path using the shear stress, the normal stress, and the aperture. In some embodiments, the reservoir parameters include seismic attributes from seismic surveys of the subsurface geological structure. In some embodiments, the reservoir parameters include rock and mechanical properties from geological models of the subsurface geological structure. In some embodiments, the reservoir parameters include rock geological characterizations of the subsurface geological structure. In some embodiments, the reservoir parameters include reservoir engineering measures obtained from production from the subsurface hydrocarbon reservoir.

In another embodiment, a system for determining a sweet spot for hydraulic fracturing stimulation in a naturally fractured tight sand hydrocarbon reservoir is provided. The system includes a processor and a non-transitory computer-readable memory accessible by the processor and having executable code stored thereon. The executable code includes a set of instructions that causes a processor to perform operations that include obtaining reservoir parameters representing properties of the subsurface reservoir for processing in a data processing system, forming a natural fracture model by processing the obtained reservoir parameters in the data processing system to identify the presence and extent of natural fractures at locations in the subsurface hydrocarbon reservoir, and identifying a fluid flow path using a shear stress, a normal stress, and an aperture of a fracture. The operations further include determining a second discrete natural fracture network identifying the presence and extent of natural fractures representing fluid flow paths in the reservoirs and determining, using the second discrete natural fracture network, a fracture density index (FDI). Determining, using the second discrete natural fracture network, a fracture density index (FDI) includes generating a raster map from the second discrete natural fracture network, the raster map representing a fracture density per area. The operations also include obtaining a flow capacity parameter for the reservoir, the flow capacity parameter obtained from a pressure test analysis (PTA), obtaining a productivity index for the reservoir, and determining a sweet spot based on the fracture density index and at least one of the flow capacity parameter and the productivity index.

In some embodiments, identifying a fluid flow path using a shear stress, a normal stress, and an aperture associated of a fracture includes determining the aperture of the fracture in the naturally fractured hydrocarbon reservoir using a resistivity, a drilling fluid resistivity, and an excess current measurement, determining a shear stress associated with the fracture, the shear stress determined from reservoir parameters representing properties of the reservoir, determining a normal stress associated with the fracture, the normal stress determined from reservoir parameters representing properties of the reservoir, and identifying a fluid flow path using the shear stress, the normal stress, and the aperture. In some embodiments, the reservoir parameters include seismic attributes from seismic surveys of the subsurface geological structure. In some embodiments, the reservoir parameters include rock and mechanical properties from geological models of the subsurface geological structure. In some embodiments, the reservoir parameters include rock geological characterizations of the subsurface geological structure. In some embodiments, the reservoir parameters include reservoir engineering measures obtained from production from the subsurface hydrocarbon reservoir.

### BRIEF DESCRIPTION OF THE DRAWINGS

The patent and application file contains at least one drawing executed in color. Copies of this patent or patent application publication with color drawing(s) will be provided by the Office upon request and payment of the necessary fee.

FIG. 1 is a flowchart of a process for identifying natural fracture sweet spots in accordance with an embodiment of the disclosure;

FIGS. 2A and 2B are flowcharts of a process for determining a discrete natural fracture distribution of a 3D fracture model in accordance with an embodiment of the disclosure;

FIG. 3 is a flowchart of a process for the determination of a 2D/3D geomechanics forward model in accordance with an embodiment of the disclosure;

FIG. 4A is a diagram illustrating fluid flow paths for hydraulically conductive and non-hydraulically conductive fractures using normal stresses in accordance with an embodiment of the disclosure;

FIG. 4B is a plot of shear stress vs normal stress and coefficient of friction in accordance with an embodiment of the disclosure;

FIG. 5A is an image of a 2D fracture network illustrating main fluid pathways in an area in accordance with an embodiment of the disclosure;

FIG. 5B is an image of a line density raster map computed from the 2D fracture network of FIG. 5A and in accordance with an embodiment of the disclosure;

FIG. 6A is an image depicting total flow capacity (PTA-KH) overlaid on a Fracture Density Index (FDI) map in accordance with an embodiment of the disclosure;

FIG. 6B is an image of the Fracture Density Index (FDI) map of FIG. 6A in accordance with an embodiment of the disclosure;

FIG. 6C is an image depicting total flow capacity (PTA-KH) overlaid on a matrix permeability map in accordance with an embodiment of the disclosure;

FIG. 7A is an image depicting productivity indices overlaid on a Fracture Density Index (FDI) map in accordance with an embodiment of the disclosure;

FIG. 7B is an image of the Fracture Density Index (FDI) map of FIG. 7A in accordance with an embodiment of the disclosure;

FIG. 7C is an image depicting productivity indices overlaid on a matrix permeability map in accordance with an embodiment of the disclosure; and

FIG. 8 is a block diagram of a data processing system in accordance with an embodiment of the disclosure.

### DETAILED DESCRIPTION

The present disclosure will be described more fully with reference to the accompanying drawings, which illustrate embodiments of the disclosure. This disclosure may, however, be embodied in many different forms and should not be construed as limited to the illustrated embodiments. Rather, these embodiments are provided so that this disclosure will be thorough and complete, and will fully convey the scope of the disclosure to those skilled in the art.

Embodiments of the disclosure include process, systems, and computer-readable media for identifying natural fracture sweet spots by integrating reservoir modeling components and reservoir dynamic data. Natural fracture predictions using geomechanics, a reservoir matrix model, and dynamic reservoir properties may be received as inputs and used to determine natural fracture sweet spots.

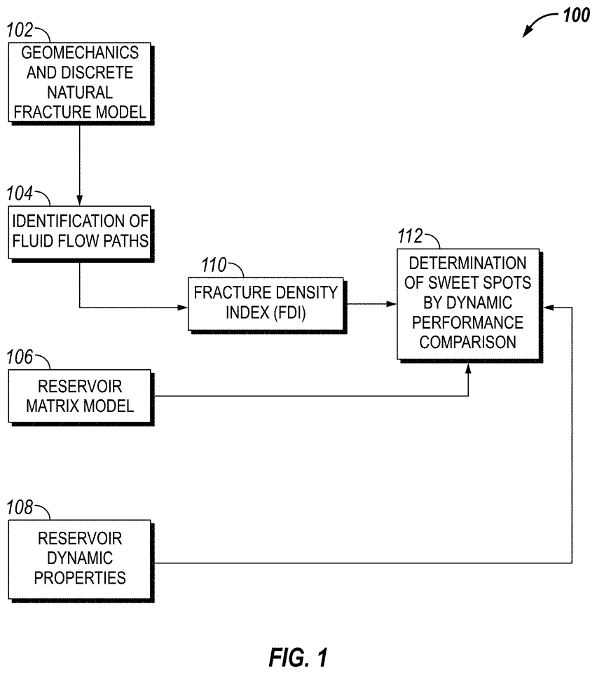

FIG. 1 depicts a process for identifying natural fracture sweet spots in accordance with an embodiment of the disclosure. The process may include determining a natural fracture distribution of a 3D fracture model using geomechanics (block 102) and identifying fluid flow pathways (block 104). Additionally, a reservoir matrix model may be constructed (block 106) to determine matrix properties such as matrix permeability and matrix flow capacity. Reservoir dynamic properties (block 108) may also be determined.

As also shown in FIG. 1, a fracture density index (FDI) (block 110) may be determined from the natural fracture distribution of the 3D fracture model (block 102) and the identified fluid flow paths (block 104). The natural fracture sweet spots may be identified (block 112) using the fracture density index, the matrix properties from the reservoir matrix model (block 106), and the reservoir dynamic properties (block 108). Each element of the process 100 is discussed supra

The determination of a natural fracture distribution of a 3D fracture model using geomechanics (block 102) may use rock mechanical properties combined with additional data like seismic, structural restoration and geomechanics determine the natural fractures. In some embodiments, the determination of a 3D fracture model and a natural fracture distribution may be performed according to the techniques described in U.S. Pat. No. 10,607,043 filed Sep. 14, 2017, and titled “SUBSURFACE RESERVOIR MODEL WITH 3D NATURAL FRACTURES PREDICTION,” a copy of which is incorporated by reference in its entirety.

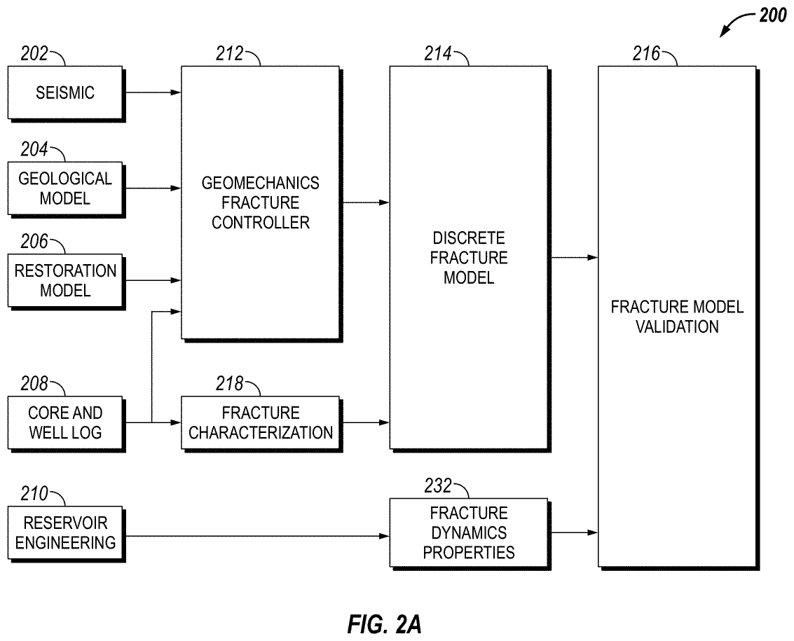

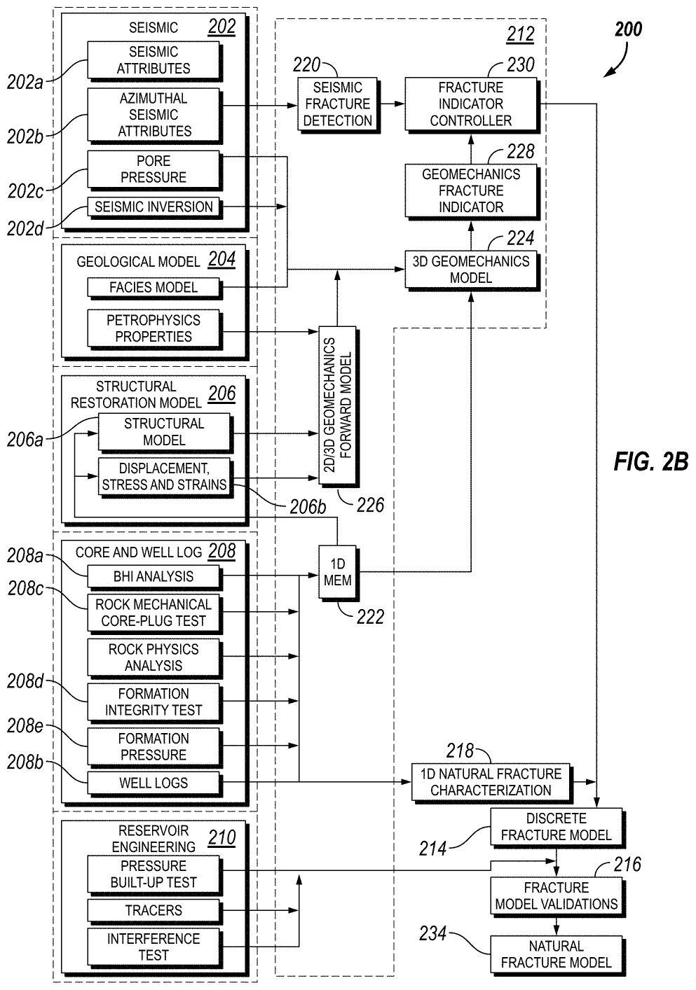

FIGS. 2A and 2B depicts a process 200 for determining a natural fracture distribution of a 3D fracture model in accordance with an embodiment of the disclosure. The inputs to the process 200 may include different reservoir parameters and properties obtained via different techniques and known earth science. As shown in FIGS. 2A and 2B, such inputs may include seismic attributes from seismic surveys (202); rock and mechanical properties from geological modeling (204); measures from structural restoration models (206); core and well logs (208) obtained from formation core samples and well logs performed in wellbores drilling into a reservoir; and reservoir engineering measures obtained (210) from production measures and reservoir simulations of a reservoir layer.

The process 200 may include a geomechanics fracture controller (212), determining a discrete fracture model (214), and validating the fracture model (216). The geomechanics fracture controller (212) may integrate the paleo-stress from structural restoration model (206) obtained for several stages in geological time, and current stress regime conditions obtained through a geomechanical numerical simulation model. In some embodiments, geomechanics fracture controller (212) may apply seismic volume interpretation techniques and attributes to detect possible faults and natural fractures alignments by using post stack discontinuities attributes, azimuthal analysis, and elastic seismic inversion.

The determination of the natural fracture model (214) may include quantifying fracture density in the subsurface reservoir layer using the output from the geomechanics fracture controller (212), and a 1D fracture characterization (218) provided from core samples and borehole well log images from a borehole image (BHI) analysis process 208a (shown in FIG. 2B). The determination of the natural fracture model (214) also includes the determination of fracture dimensions and their properties into the discrete fracture model, described in the disclosure. Examples of the fracture properties resulting from the determination of the natural fracture model (214) include fracture position, orientation, geometry, porosity, aperture, permeability, and the like. In other embodiments, other fracture properties may also be estimated during the determination of the natural fracture model (214).

The validation of the fracture model (216) may include cross-checking or validating the model using reservoir production data. In some embodiments, the natural fracture model may be upscaled to conform to a fine-scale cell grid of geological model and reproduce the natural fracture distribution and their properties, for comparison with the reservoir production data for validation proposes. Several types of reservoir production data can be used to calibrate the fracture models with reservoir engineering data. Examples of such reservoir production data are results of measures obtained from: PTA (Pressure Transient Analysis), tracers, drilling operation events, PLT (production logs), and the like. In other embodiments, other reservoir production data can also be used for cross-checking during the validation of the fracture model (216).

FIG. 2B depicts aspects of the geomechanics fracture controller (212) in further detail in accordance with an embodiment of the disclosure. As shown in FIG. 2B, a seismic fracture detection process (220) is provided with seismic attributes (202a) obtained from seismic volume results (202). The seismic attributes (202a) may include attributes related to natural fractures detections or dislocation detections. Examples of such attributes obtained from the seismic dislocations attribute analysis results may include: variance, anti-tracking, flatness, curvature, and the like. In other embodiments, other seismic attributes may also be provided. As will be appreciated, seismic fracture attributes may be unable to be compared straight forward at wellbore scale due to resolutions issues. However, seismic attributes may be used as a seismic fracture controller or conduct for minor fractures detected at wellbore scale if the relations regarding to the locations and intensity between them exist.

As shown in FIG. 2B, advance seismic fracture detection may also be performed during the seismic fracture detection process (220) using azimuthal seismic analysis (202b) to capture the variations of the wave propagation at different directions. Such variations in wave propagation form anisotropic volumes in the reservoir layer and are helpful in detecting fractures. This azimuthal analysis may be based on whether the anisotropy response in the reservoir is due to natural fractures or caused by another reason. In order to identify whether the anisotropy response may be azimuthal shear anisotropy, sonic acoustic acquisition may be performed at a well location in the naturally fractured reservoir. An example of azimuthal seismic analysis is described in: Gray, F. D. and Head, K. J., 2000, Fracture Detection in the Manderson Field: A 3D AVAZ Case History: The Leading Edge, Vol. 19, No. 11, 1214- 1221; and Khalid Al-Hawas, Mohammed Ameen, Mohammad Wahab, and Ed Nebrija, Saudi Aramco, Dhahran, Saudi Arabia Colin Macbeth, Heriot-Watt University, Edinburgh, U.K., 2003, “Delineation of Fracture Anisotropy Signatures in Wudayhi Field by azimuthal seismic data”, the Leading Edge.

The geomechanics fracture controller (212) may include a determination of a 1D mechanical earth model (MEM) (222) to determine the rock mechanical properties and stress regime conditions in the reservoir layer. The determination of the 1D MEM may include computing the elastic rock mechanical properties deriving from well logs (208b) and rock mechanical test (208c); using additional information such as reservoir formation pressures (208e) and a Formation Integrity Test (FIT)) 208d), the in situ stress regime can be predicted and mechanical stratigraphy (Geomechanical Facies) computed. The mechanical stratigraphy may conform the rock mechanical response to the geological deformation process and may be used as constraints for natural fractures presence, constraining their development to some particular layer through brittleness concepts, depending also on the deformation magnitude. Additionally, the maximum horizontal stress direction may be detected by the Borehole Image Analysis (BHI) (208a), and the in situ stress magnitude derived from the 1D MEM may be used to predict the stress regime of a 3D geomechanics model (224) (also referred to as a “3D mechanical earth model (MEM)”).

As shown in FIG. 2B, the geomechanics fracture controller (212) may include the determination of 2D/3D geomechanics forward model (226) that combines a structural model (208a) and displacement, paleo-stress, and strain measures 208b from the structural restoration model (208) with petrophysical properties (204b) from geological model (204). The results take the form of structural restoration as horizons displacement and deformation using boundary conditions. The determination of 2D/3D geomechanics forward model (226) may include as a Finite Element Method (FEM) using geomechanics numerical simulation software, to estimate the tensor stress regime corresponding to the deformation estimate from structural restoration at the in situ stress conditions.

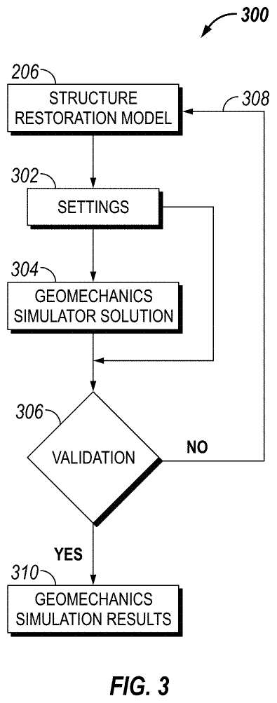

FIG. 3 depicts a process 300 of the determination of 2D/3D geomechanics forward model (226) in accordance with an embodiment of the disclosure. The initial parameter and strain boundary conditions may be defined for the numerical simulation and processing may be iteratively repeated until an equilibrium stress is obtained according to present to in situ stress conditions in the reservoir. As will be appreciated, a number of geomechanics simulator methodologies are commercially available and are able to estimate stress conditions using the deformation model from the structural restoration model. These results can be used to calculated or predict the possible origin for the natural fractures as stretching zones, compression zones which is an input to classify the different kind of natural fractures and their possible orientations from a qualitative perspective, using a strain tensor derivate from the 2D/3D geomechanics forward model (226). Example geomechanics simulator methodologies include ABAQUS™ from Dassault Systemes; VISAGE™ from Schlumberger; and ELFEN™ from Rockfield, COMSOL™ from AltaSim Technologies.

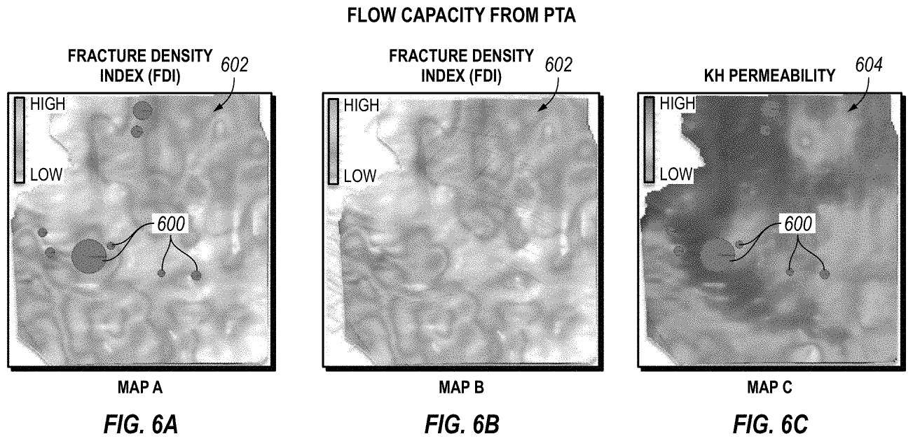

As shown in FIG. 3, input measures from the structural restoration modeling (206) are received for the 2D/3D geomechanics forward model (226) and stored as initial settings (302). The settings (302) are then processed by a geomechanics simulator (304) of the type described above. The output from the geomechanics simulator is then cross-checked or validated (306) against specified stress equilibrium conditions. As shown in FIG. 6, if confirmation results are not achieved during the current iteration (line 308), the previous settings of the step are adjusted for iteration by simulation step. The iterations may be repeated until specified conditions are validated. After validation, the simulation results (310) may be provided as the 2D/3D geomechanics forward model (226) and may indicate conditions of stress, strain and pre-existing faults and fractures in the reservoir layer.

The 3D geomechanics model (224) of the geomechanics fracture controller (212) may include the measures and indications of rock mechanical properties distribution. The 3D geomechanics model (224) may further include elastic rock properties and rock strength throughout the 3D geological grid. The 3D geomechanics model (224) may be calculated by boundary conditions to simulate the in situ stress regime. As discussed in the disclosure, the in situ stress regime is a condition where the stress field is unperturbed or is in equilibrium without any production or influences of perforated wells.

The determination of the 3D geomechanics model (224) may use elastic seismic inversion (202d) in the form of acoustic impedance, bulk density, and may also include pore pressure (202c) covering the 3D geological model area. The seismic inversion parameters may be obtained from an elastic seismic inversion (202d) and seismic velocity analysis for the pore pressure (202c). The determination of the 3D geomechanics model (224) may also be based on rock mechanical correlations between dynamics and static elastic rock mechanical properties which have been determined as a result of the 1D mechanical earth model (MEM) (222). 3D mechanical stratigraphy may also be calculated using the elastic properties of the 3D geomechanics model (224), and may be used to constrain the fracture distribution using brittleness property definition. An example processing methodology for determining the 3D geomechanics model (224) is described in: Herwanger, J. and Koutsabeloulis, N. C.: “Seismic Geomechanics—How to Build and Calibrate Geomechanical Models using 3D and 4D Seismic Data”, 1 Edn., EAGE Publications b.v., Houten, 181 pp., 2011.

Additionally, geomechanics forward modeling of the type described infra and shown in FIG. 3 may be used as a loop process between the 2D/3D geomechanics forward model (226) and 3D geomechanics model (224). Such a loop process may capture the displacement and deformation quantified in the structural restoration model (206), and may provide more accurate calculations of the strain distribution corresponding to the structural evolution faulting and folding in the model (206).

The determination of the 3D geomechanics model (226) may include a geomechanics fracture indicator (228) that may form indications of fractures based on selected rock mechanical properties distributed for the 3D geomechanics model (224). The mechanical stratigraphy may be defined in the 3D geomechanics model (224) by using the Brittleness concept and may be used as a geomechanics fracture indicator to define the fracture position and density or spacing through the layering. A strain or plastic strain model may be determined in the 2D/3D geomechanics forward model (226) and 3D geomechanics model (224) and may be used as indicator of fracture orientation (dip and azimuth) and possible areal/volumetric density distribution, according to the kind of geological structural environment. Several components of fractures can be considered as geomechanics indicator for fractures, such as fractures relate to folding and fractures related to faulting. The quantifications about the strain may be qualitative in terms of real fracture density present in the reservoir.

As shown in FIG. 2B, the determination of the 3D geomechanics model (224) may include a fracture indicator controller (230). The fracture indicator controller (230) may compare attributes determined from seismic fracture detection (220) and geomechanics fracture indicator (228) in terms of fracture position, fracture density and orientation in a qualitative way, to evaluate possible coincidence zones, between the models, where natural fractures can be expected to be created. In some cases, the attributes determined from seismic fracture detection (220) and geomechanics fracture indicator (228) may be complementary due to the different vertical and areal resolution in which both of them are calculated.

The discrete fracture model (214) may be determined subsequent to identification of natural fracture locations by the fracture indicator controller (230). The discrete fracture model may build a representative natural fracture model based on stochastic mathematical simulations. As shown in FIG. 2B, the discrete fracture model (214) may be constructed from the fracture indicator controller (230) and the intensity and orientation from the 1D natural fracture characterization (218).

The determination of the discrete fracture model (214) may receive as input the results of the 1D natural fracture characterization (218), which may be obtained from the borehole image resistivity analysis or acoustic image interpretation (208a) of the core and well logs (208) and may represent the intensity fracture, aperture, fracture classification and fracture orientation along a wellbore.

As noted infra, the discrete fracture model (214) may be determined using the fracture indicator controller (230) and the 1D natural fracture characterization (218). The determination may constrain the orientation and fracture intensity in a qualitative way, and using the 1D natural fracture characterization (218), may calculate the real fracture intensity quantification. This output can be used to predict a natural fracture model through the discrete fracture network methodology. For fracture intensity quantification purposes the fracture intensity derived from the fracture indicator controller (230) may be normalized for comparison with the BHI fracture intensity derived from the 1D natural fracture characterization (218).

The fracture model validation 216 may validate the discrete fracture model (214). The validation may be performed using reservoir production data. As shown in FIG. 2B, Several types of data may be used as fracture dynamic properties (232) to calibrate the fracture model with reservoir engineering measures (210). For example, results from a PTA (Pressure Transient Analysis) test, or measures from tracers, drilling operations, production logs, and the like may be used. For example, pressure transient analysis can estimate permeability contribution due to fracture presence and the capacity for fluid flow due to the fractures presence. In another example, tracer injection, production logs, interference test and possibly some drilling events as can indicate mud loss circulation that can provide evidence of the presence of natural fractures. The discrete fracture model (214) may upscale into the fine-scale cell grid geological model, and reproduce the natural fracture distribution and their properties to compare with the validation data.

After the fracture model validation, a discrete natural fracture model (234) may be produced as a result of the process 200. As previously described, the discrete natural fracture model (234) may indicate the presence and extent of natural fractures in the subsurface geological structures.

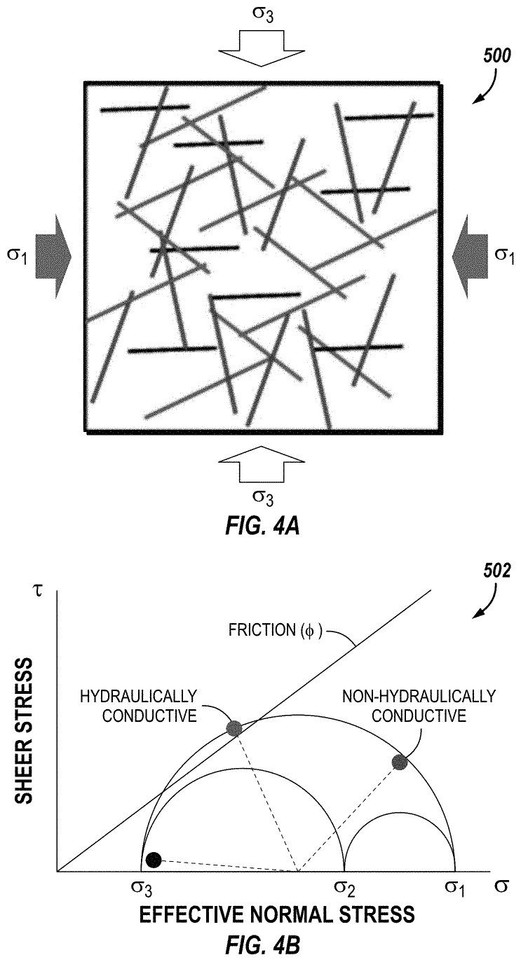

The process 100 also includes identifying fluid flow pathways (block 104). The identification of fluid flow pathways may include determining critical fractures in the reservoir of interest may be determined. As will be appreciated, critical stress depends on the stress magnitude and the orientation of the fracture plane with respect to the in-situ stress orientation. The stress orientation affects the normal and shear stresses acting in the fracture plane. When normal and shear stress exceed the friction angle (for non-intact rock), the shearing may produce dilation that keeps the fracture hydraulically open. Fractures in this state may be referred to as “reactivated,” “critically stressed,” or as a “fluid flow path.” FIG. 4A is a diagram 400 illustrating fluid flow paths for hydraulically conductive and non-hydraulically conductive fractures using normal stresses (σ₁ and σ₃) in accordance with an embodiment of the disclosure. FIG. 4B is a plot 402 of shear stress vs normal stress and coefficient of friction in accordance with an embodiment of the disclosure. FIG. 4B illustrates “Mohr circles” 404, 406, and 408, as is known in the art.

Shear failure may be caused by two perpendicular stresses acting on the same plane, and is defined in conjunction with a Mohr circle by the following equation expressing stress conditions shown schematically in FIG. 4B:

σ1′≥C0+σ3′ tan 2β (1)

Where C0 is the unconfined compressive strength, σ1′ is the maximum effective stress, σ3′ is the minimum effective stress, and β is the angle between the normal stress and the maximum effective stress σ1′, such is β is determined as follows:

$$β = 45 ° + \frac{ϕ}{2} \qquad ( 2 )$$

Where ϕ is the friction angle.

If the maximum effective stress σ1′ is exceeded, then the conditions for shear failure are satisfied.

In some embodiments, fluid flow paths may be identified according to the techniques described in U.S. patent application Ser. No. 17/476,914 filed Sep. 16, 2021, and titled “IDENTIFYING FLUID FLOW PATHS IN NATURALLY FRACTURED RESERVOIRS,” a copy of which is incorporated by reference in its entirety. For example, in some embodiments normal effective stress and shear stress may be determined. In terms of stress tensor components σ_{i,j} the normal stress may be defined as the product of stress vector multiplied by normal unit vector σₙ=T⁽ⁿ⁾.n and the magnitude of the shear stress (τₙ) component as defined in Equation 3:

τₙ=\sqrt{(T⁽ⁿ⁾)²−σₙ} (3)

A fluid flow path may be determined from shear stress and normal effective stress as shown in Equation 3:

Fluid flow path=(τ−σₙ*Tan(φ))≥0 (4)

In some embodiments, fluid flow paths for a fracture network in a rock matrix may be identified by using determined apertures combined with the normal effective stress and shear stress. The largest aperture corresponds to the greatest distance between the points and the failure Mohr Coulomb line (that is, the friction angle for non-intact rock). In some embodiments, apertures may be determined from microresistivity logs calibrated microresistivity arrays, the fracture dataset, shallow resistivity, and drilling mud resistivity. The fracture aperture determination may be performed using Equation 1:

W=cARₘ^{b}Rₓₒ^{1-b} (5)

where W is the fracture width (that is, aperture), Rxo is the flushed zone resistivity, Rm is the mud resistivity, and A is the excess current flowing into the rock matrix through the conductive media due to the presence of the fracture. The excess current is a function of the fracture width and may be determined from statistical and geometrical analysis of the anomaly it creates as compared to background conductivity. For example, the excess current may be determined by dividing by voltage and integrating along a line perpendicular to the fracture trace. The term c is a constant and b is numerically obtained tool-specific parameter (that is, specific to the resistivity tools). As will be appreciated, a greater fracture aperture (W) indicates a more open fracture that is likely to flow hydrocarbons or other fluids, and a lesser fracture aperture indicates a fracture that will likely have reduced or low flow to hydrocarbons or other fluids.

The determined fracture aperture mean values may be provided in two forms: as sinusoids along fractures and as a secondary track with the mean value points. In addition to the mean fracture aperture, the hydraulic mean fracture aperture may be determined using Equation 2:

$$FVAH = \sqrt[3]{\frac{\sum ( length \times {aperture}^{3} )}{Total Length}} \qquad ( 6 )$$

where FVAH is the hydraulic mean fracture aperture.

The process 100 may also include determination of a reservoir matrix model (block 106). The reservoir matrix model may include a determination of matrix permeability and matrix flow capacity. The reservoir matrix model may be determined from petrophysical workflows using combined core test and wireline log data. For example, the matrix permeability determined from such data may be modeled into a conventional 3D geocellular grid, using algorithms for correlations and distribution. The core plug data may include measurements of porosity, permeability, grain density, obtained using standard Conventional Core Analysis techniques as known in the art.

The process 100 may also include the use of reservoir dynamic properties (block 108). The reservoir dynamic properties may be determined by field measurements and operations in well accessing a reservoir. Such measurements may indicate reservoir fluid movement and may include: flow capacity from Pressure Transient Analysis (PTA), productivity index (PI), cumulative fluids, flowmeter logs, and water encroachment.

As known in the art, PTA provides a measurement of the reservoir pressure changes over time. In most well tests, a limited amount of fluid can flow from the formation being tested, and the pressure of the formation is monitored over time. The well may then be closed and the pressure monitored while the fluid within the formation equilibrates. The analysis of these pressure changes may provide information on the size and shape of the formation. The total flow capacity (PTA-KH) of the formation may be determined from the measurements.

The productivity index (PI) is an expression of the ability of a reservoir to deliver fluids to the wellbore at a pressure drawdown. In some embodiments, the productivity index may be determined from fluid production rate normalized by the bottomhole pressure (BHP). The fluid production rate may be directly determined from fluid flow measurements, such as a surface flow rate at standard conditions (for example, in stock tank barrel/day (STD/D) from downhole measurements in the reservoir . The bottomhole pressure (for example, in pounds per square inch (psi)) may refer to a shut-in pressure and may be determined using known techniques, such as for example surface readout measurements, downhole recording measurements, or a calculation from mud weight and depth.

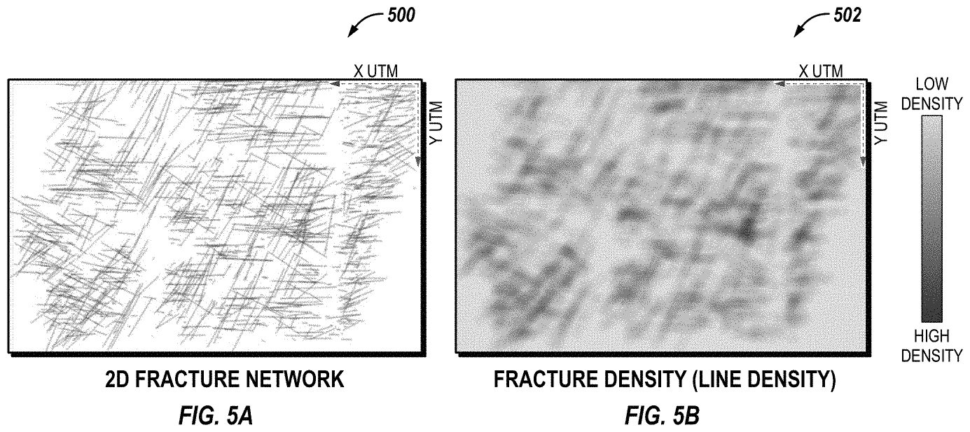

Next, as shown in FIG. 1, a fracture density index (FDI) model may be determined from the natural fracture model and the identified fluid-flow pathways (block 110). The 3D discrete fracture network determined from the geomechanics model may be converted into 2D lines to compute a continuous fracture density property. For example, various geographic information systems (GIS) geoprocessing software may have tools for computing line density. In some embodiments, the conversion of the 3D discrete fracture map to 2D lines may be performed by ArcGIS available from Environmental Systems Research Institute (Ersi), California, USA. In such embodiments, a raster map representing fracture density per area may be generated. Additionally, a suitable color-indexed palette may be assigned to enable visual identification of areas where natural fractures are more concentrated. FIG. 5A depicts a 2D fracture network 500 illustrating main fluid pathways in an area in accordance with an embodiment of the disclosure. FIG. 5B depicts a line density raster map 502 computed from the 2D fracture network of FIG. 5A in accordance with an embodiment of the disclosure.

The natural fracture sweet spots may be identified using the fracture density index (FDI), the reservoir matrix model, and the reservoir dynamic properties (block 112). In particular, the identification includes a spatial analysis between the Fracture Density Index (FDI) and matrix permeability versus total flow capacity (PTA-KH) and Productivity Index (PI) to identify sweet spots for natural fractures impacting reservoir fluid behavior.

By way of example, FIGS. 6A- 6C depict a spatial analysis with a total flow capacity (PTA-KH). FIG. 6A depicts total flow capacity (PTA-KH) 600 overlaid on a Fracture Density Index (FDI) map 602 in accordance with an embodiment of the disclosure. As shown in FIG. 6A, the anomalous greater PTA-KH (as indicated by the larger colored circles) may only be explained due to the presence of highly dense fracture regions, as the FDI map indicates. FIG. 6B depicts the Fracture Density Index (FDI) map 602 and corresponding color-coded fracture density magnitudes, as indicated by the legend, in accordance with an embodiment of the disclosure.

FIG. 6C depicts total flow capacity (PTA-KH) 600 overlaid on a matrix permeability map 604 in accordance with an embodiment of the disclosure. In contrast to FIG. 6A, the low matrix permeability in the regions having an anomalous greater PTA-KH (as indicated by the larger colored circles) does not account for these greater PTA-KH values measured in the depicted area.

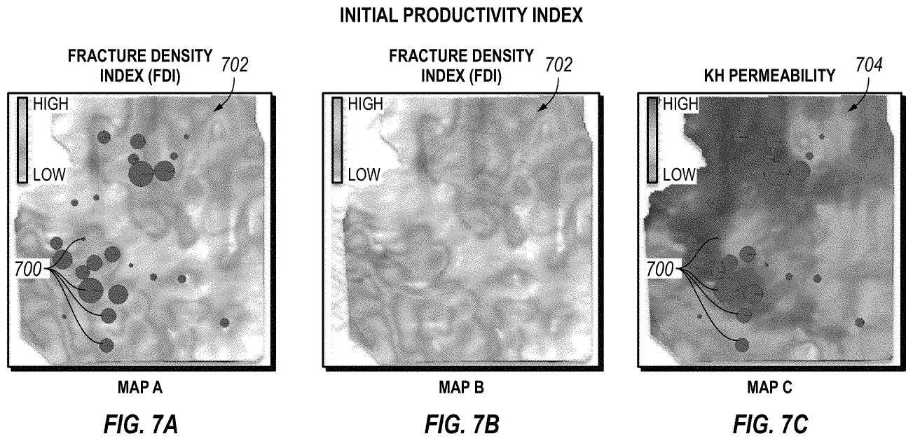

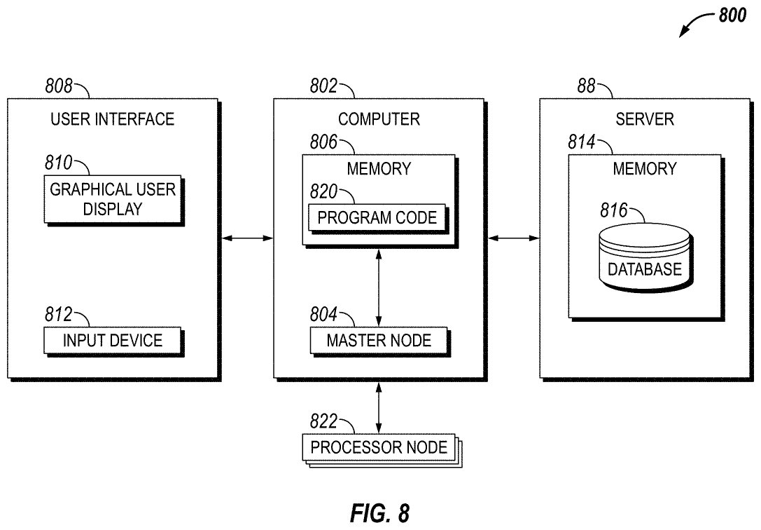

In some embodiments, the spatial analysis may include the hydrocarbon productivity index (PI). In such embodiments, the hydrocarbon productivity index may exhibit similar correlations as those of total flow capacity (PTA-KH). By way of example, FIGS. 7A-7C depict a spatial analysis with the hydrocarbon productivity index (PI). FIG. 7A depicts hydrocarbon productivity index (PI) 700 overlaid on the Fracture Density Index (FDI) map 702 in accordance with an embodiment of the disclosure. As shown in FIG. 7A, greater productivity indices (as indicated by the larger colored circles) correspond to greater fracture densities. FIG. 7B depicts the Fracture Density Index (FDI) map 702 and corresponding color-coded fracture density magnitudes, as indicated by the legend, for comparison with FIGS. 7A and 7B.

FIG. 7C depicts hydrocarbon productivity index (PI) 700 overlaid on a matrix permeability map 704 in accordance with an embodiment of the disclosure. In contrast to FIG. 7A, the matrix permeability does not show a correlation with the regions having greater productivity indices (as indicated by the larger colored circles).

Accordingly, a Fracture Density Index map may enable an understanding of reservoir fluid behavior by providing a qualitative evaluation of natural fracture sweet spots important for field development and well placement.

FIG. 8 depicts a data processing system 800 that includes a computer 802 having a master node processor 804 and memory 806 coupled to the processor 804 to store operating instructions, control information and database records therein in accordance with an embodiment of the disclosure. The data processing system 800 may be a multicore processor with nodes such as those from Intel Corporation or Advanced Micro Devices (AMD), or an HPC Linux cluster computer. The data processing system 800 may also be a mainframe computer of any conventional type of suitable processing capacity such as those available from International Business Machines (IBM) of Armonk, N.Y., or other source. The data processing system 800 may in cases also be a computer of any conventional type of suitable processing capacity, such as a personal computer, laptop computer, or any other suitable processing apparatus. It should thus be understood that a number of commercially available data processing systems and types of computers may be used for this purpose

The computer 802 is accessible to operators or users through user interface 808 and are available for displaying output data or records of processing results obtained according to the present disclosure with an output graphic user display 810. The output display 810 includes components such as a printer and an output display screen capable of providing printed output information or visible displays in the form of graphs, data sheets, graphical images, data plots and the like as output records or images.

The user interface 808 of computer 802 also includes a suitable user input device or input/output control unit 812 to provide a user access to control or access information and database records and operate the computer 802. Data processing system 800 further includes a database of data stored in computer memory, which may be internal memory 806, or an external, networked, or non-networked memory as indicated at 814 in an associated database 816 in a server 88.

The data processing system 800 includes executable code 820 stored in non-transitory memory 806 of the computer 802. The executable code 820 according to the present disclosure is in the form of computer operable instructions causing the data processor 804 to determine geomechanical components, determine a discrete natural fracture model, identify fluid flow paths, determine a fracture density index (FDI) map, and determine sweet spots, according to the present disclosure in the manner set forth.

It should be noted that executable code 820 may be in the form of microcode, programs, routines, or symbolic computer operable languages capable of providing a specific set of ordered operations controlling the functioning of the data processing system 800 and direct its operation. The instructions of executable code 820 may be stored in memory 806 of the data processing system 800, or on computer diskette, magnetic tape, conventional hard disk drive, electronic read-only memory, optical storage device, or other appropriate data storage device having a non-transitory computer readable storage medium stored thereon. Executable code 820 may also be contained on a data storage device such as server 88 as a non-transitory computer readable storage medium, as shown.

The data processing system 800 may be include a single CPU, or a computer cluster as shown in FIG. 8, including computer memory and other hardware to make it possible to manipulate data and obtain output data from input data. A cluster is a collection of computers, referred to as nodes, connected via a network. A cluster may have one or two head nodes or master nodes 804 used to synchronize the activities of the other nodes, referred to as processing nodes 822. The processing nodes 822 each execute the same computer program and work independently on different segments of the grid which represents the reservoir.

Ranges may be expressed in the disclosure as from about one particular value, to about another particular value, or both. When such a range is expressed, it is to be understood that another embodiment is from the one particular value, to the other particular value, or both, along with all combinations within said range.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described in the disclosure. It is to be understood that the forms shown and described in the disclosure are to be taken as examples of embodiments. Elements and materials may be substituted for those illustrated and described in the disclosure, parts and processes may be reversed or omitted, and certain features may be utilized independently, all as would be apparent to one skilled in the art after having the benefit of this description. Changes may be made in the elements described in the disclosure without departing from the spirit and scope of the disclosure as described in the following claims. Headings used in the disclosure are for organizational purposes only and are not meant to be used to limit the scope of the description.

What is claimed is:

1. A method for determining a sweet spot in a naturally fractured hydrocarbon reservoir, the method comprising:
obtaining reservoir parameters representing properties of the subsurface reservoir for processing in a data processing system;
forming a natural fracture model by processing the obtained reservoir parameters in the data processing system to identify the presence and extent of natural fractures at locations in the subsurface hydrocarbon reservoir;
identifying a fluid flow path using a shear stress, a normal stress, and an aperture of a fracture;
determining a second discrete natural fracture network identifying the presence and extent of natural fractures representing fluid flow paths in the reservoirs;
determining, using the second discrete natural fracture network, a fracture density index (FDI), wherein determining, using the second discrete natural fracture network, a fracture density index (FDI) comprises generating a raster map from the second discrete natural fracture network, the raster map representing a fracture density per area;
obtaining a flow capacity parameter for the reservoir, the flow capacity parameter obtained from a pressure test analysis (PTA);
obtaining a productivity index for the reservoir; and
determining a sweet spot based on the fracture density index and at least one of the flow capacity parameter and the productivity index.

2. The method of claim 1, wherein identifying a fluid flow path using a shear stress, a normal stress, and an aperture associated of a fracture comprises:
determining the aperture of the fracture in the naturally fractured hydrocarbon reservoir using a resistivity, a drilling fluid resistivity, and an excess current measurement;
determining a shear stress associated with the fracture, the shear stress determined from reservoir parameters representing properties of the reservoir;
determining a normal stress associated with the fracture, the normal stress determined from reservoir parameters representing properties of the reservoir; and
identifying a fluid flow path using the shear stress, the normal stress, and the aperture.

3. The method of claim 1, wherein the reservoir parameters comprise seismic attributes from seismic surveys of the subsurface geological structure.

4. The method of claim 1, wherein the reservoir parameters comprise rock and mechanical properties from geological models of the subsurface geological structure.

5. The method of claim 1, wherein the reservoir parameters comprise structural restoration models of the subsurface geological structure.

6. The method of claim 1, wherein the reservoir parameters comprise rock geological characterizations of the subsurface geological structure.

7. The method of claim 1, wherein the reservoir parameters comprise reservoir engineering measures obtained from production from the subsurface hydrocarbon reservoir.

8. The method of claim 1, comprising drilling a well in a subsurface geological structure to a location in the hydrocarbon reservoir based on the identified sweet spot.

9. A non-transitory computer-readable storage medium having executable code stored thereon for determining a sweet spot in a naturally fractured hydrocarbon reservoir, the executable code comprising a set of instructions that causes a processor to perform operations comprising:
obtaining reservoir parameters representing properties of the subsurface reservoir for processing in a data processing system;
forming a natural fracture model by processing the obtained reservoir parameters in the data processing system to identify the presence and extent of natural fractures at locations in the subsurface hydrocarbon reservoir;
identifying a fluid flow path using a shear stress, a normal stress, and an aperture of a fracture;
determining a second discrete natural fracture network identifying the presence and extent of natural fractures representing fluid flow paths in the reservoirs;
determining, using the second discrete natural fracture network, a fracture density index (FDI), wherein determining, using the second discrete natural fracture network, a fracture density index (FDI) comprises generating a raster map from the second discrete natural fracture network, the raster map representing a fracture density per area;
obtaining a flow capacity parameter for the reservoir;
obtaining a productivity index for the reservoir; and
determining a sweet spot based on the fracture density index and at least one of the flow capacity parameter and the productivity index.

10. The non-transitory computer-readable media of claim 9, wherein identifying a fluid flow path using a shear stress, a normal stress, and an aperture associated of a fracture comprises:
determining the aperture of the fracture in the naturally fractured hydrocarbon reservoir using a resistivity, a drilling fluid resistivity, and an excess current measurement;
determining a shear stress associated with the fracture, the shear stress determined from reservoir parameters representing properties of the reservoir;
determining a normal stress associated with the fracture, the normal stress determined from reservoir parameters representing properties of the reservoir; and
identifying a fluid flow path using the shear stress, the normal stress, and the aperture.

11. The non-transitory computer-readable media of claim 9, wherein the reservoir parameters comprise seismic attributes from seismic surveys of the subsurface geological structure.

12. The non-transitory computer-readable media of claim 9, wherein the reservoir parameters comprise rock and mechanical properties from geological models of the subsurface geological structure.

13. The non-transitory computer-readable media of claim 9, wherein the reservoir parameters comprise structural restoration models of the subsurface geological structure.

14. The non-transitory computer-readable media of claim 9, wherein the reservoir parameters comprise rock geological characterizations of the subsurface geological structure.

15. The non-transitory computer-readable media of claim 9, wherein the reservoir parameters comprise reservoir engineering measures obtained from production from the subsurface hydrocarbon reservoir.

16. A system for determining a sweet spot for hydraulic fracturing stimulation in a naturally fractured tight sand hydrocarbon reservoir, comprising:
a processor;
a non-transitory computer-readable memory accessible by the processor and having executable code stored thereon, the executable code comprising a set of instructions that causes a processor to perform operations comprising:
obtaining reservoir parameters representing properties of the subsurface reservoir for processing in a data processing system;
forming a natural fracture model by processing the obtained reservoir parameters in the data processing system to identify the presence and extent of natural fractures at locations in the subsurface hydrocarbon reservoir;
identifying a fluid flow path using a shear stress, a normal stress, and an aperture of a fracture;
determining a second discrete natural fracture network identifying the presence and extent of natural fractures representing fluid flow paths in the reservoirs;
determining, using the second discrete natural fracture network, a fracture density index (FDI), wherein determining, using the second discrete natural fracture network, a fracture density index (FDI) comprises generating a raster map from the second discrete natural fracture network, the raster map representing a fracture density per area;
obtaining a flow capacity parameter for the reservoir;
obtaining a productivity index for the reservoir; and
determining a sweet spot based on the fracture density index and at least one of the flow capacity parameter and the productivity index.

17. The system of claim 16, wherein identifying a fluid flow path using a shear stress, a normal stress, and an aperture associated of a fracture comprises:
determining the aperture of the fracture in the naturally fractured hydrocarbon reservoir using a resistivity, a drilling fluid resistivity, and an excess current measurement;
determining a shear stress associated with the fracture, the shear stress determined from reservoir parameters representing properties of the reservoir;
determining a normal stress associated with the fracture, the normal stress determined from reservoir parameters representing properties of the reservoir; and
identifying a fluid flow path using the shear stress, the normal stress, and the aperture.

18. The system of claim 16, wherein the reservoir parameters comprise seismic attributes from seismic surveys of the subsurface geological structure.

19. The system of claim 16, wherein the reservoir parameters comprise rock and mechanical properties from geological models of the subsurface geological structure.

20. The system of claim 16, wherein the reservoir parameters comprise structural restoration models of the subsurface geological structure.

21. The system of claim 16, wherein the reservoir parameters comprise rock geological characterizations of the subsurface geological structure.

22. The system of claim 16, wherein the reservoir parameters comprise reservoir engineering measures obtained from production from the subsurface hydrocarbon reservoir.
